(19) United States
(12) Patent Application Publication
(10) Pub. No.: US 2011/0084646 A1
(43) Pub. Date: Apr. 14, 2011

(54) Off-grid led street lighting system with multiple panel-storage matching

(75) Inventors: Gianpaolo Lisi, Campbell, CA (US); Ali Djabbari, Saratoga, CA (US)

(73) Assignee: National Semiconductor Corporation, Santa Clara, CA (US)

(21) Appl. No.: 12/925,110

(22) Filed: Oct. 14, 2010

Related U.S. Application Data
(60) Provisional application No. 61/278,923, filed on Oct. 14, 2009.

(51) Int. Cl. H02J 7/00

(52) U.S. Cl. 320/101

(57) ABSTRACT

A system includes multiple photovoltaic panels having a combined output profile that defines energy or power generated by the photovoltaic panels over time. Each photovoltaic panel is configured to generate a peak amount of energy or power at a different time. The system also includes a storage device having a charging profile and configured to be charged by the photovoltaic panels. The charging profile defines a maximum amount of energy or power sinkable by the storage device at a given time. The output profile and the charging profile are substantially matched such that a maximum level of the output profile is approximately equal to the maximum amount of energy or power sinkable by the storage device. The maximum level of the output profile could be substantially constant over time between first and second peak amounts of energy or power generated by different photovoltaic panels.

CROSS-REFERENCE TO RELATED APPLICATIONS AND PRIORITY CLAIM

This application claims priority under 35 U.S.C. §119(e) to U.S. Provisional Patent Application No. 61/278,923 filed on Oct. 14, 2009, which is hereby incorporated by reference.

This application is also related to the following pending U.S. patent applications, which are all hereby incorporated by reference:
U.S. patent application Ser. No. 12/152,479;
U.S. patent application Ser. No. 12/152,566;
U.S. patent application Ser. No. 12/152,491;
U.S. patent application Ser. No. 12/152,478;
U.S. Provisional Patent Application No. 61/170,582;
U.S. patent application Ser. No. 12/454,244;
U.S. patent application Ser. No. 12/454,136;
U.S. patent application Ser. No. 12/456,776; and
U.S. patent application Ser. No. 12/456,777.

### TECHNICAL FIELD

This disclosure relates generally to solar-powered street lighting systems. More specifically, this disclosure relates to an off-grid light emitting diode (LED) street lighting system with multiple panel-storage matching.

### BACKGROUND

“Off-grid” street lighting systems are becoming more and more popular due to the energy and cost savings that can be achieved with these types of systems. Systems that combine photovoltaic panels (solar panels), batteries, and light emitting diodes (LEDs) are a convenient solution to deploy street lighting in areas that lack electric power distribution infrastructure.

Solar irradiation of a photovoltaic panel is generally not constant. Of course, solar irradiation becomes virtually zero at night, but the solar irradiation can vary even during the day. In a conventional street lighting system, photovoltaic panels are typically oriented in the same direction. This allows the photovoltaic panels to obtain a single-peak power-to-voltage characteristic and to harvest a maximum amount of instantaneous power during peak hours. In these conditions, maximum power production can be achieved using a control technique known as Maximum Power Point Tracking (MPPT).

Conventional street lighting systems often include at least one photovoltaic panel that is coupled to a single MPPT stage and a charge controller. The MPPT stage and charge controller are coupled to a battery bank having one or more batteries, and the battery bank is coupled to a direct current-to-direct current (DC-to-DC) converter. The DC-to-DC converter is coupled to LEDs that are used to produce illumination.

In conventional street lighting systems, matching a battery's charging profile to a photovoltaic panel array's energy output profile is problematic. As a result, during certain hours of the day, the power generated by the photovoltaic panels may exceed the maximum power that the battery bank can sink. In these conditions, the charge controller may have to either completely disconnect the photovoltaic panels or limit the power being extracted from the photovoltaic panels. This wastes energy that could potentially be utilized. Alternatively, this may cause larger batteries to be used so that the power generated by the photovoltaic panels cannot exceed the maximum power that the battery bank can sink. However, this increases the size and cost of the street lighting system.

### BRIEF DESCRIPTION OF DRAWINGS

For a more complete understanding of this disclosure and its features, reference is now made to the following description, taken in conjunction with the accompanying drawings, in which:

FIG. 1 illustrates an example off-grid street lighting system in accordance with this disclosure;

FIG. 2 illustrates example components in the street lighting system of FIG. 1 in accordance with this disclosure;

FIGS. 3A and 3B illustrate example details of matching an energy storage device's charging profile and multiple photovoltaic panels' energy output profile in accordance with this disclosure; and

FIG. 4 illustrates an example method for powering an off-grid street lighting system using multiple panel-storage matching according to this disclosure.

### DETAILED DESCRIPTION

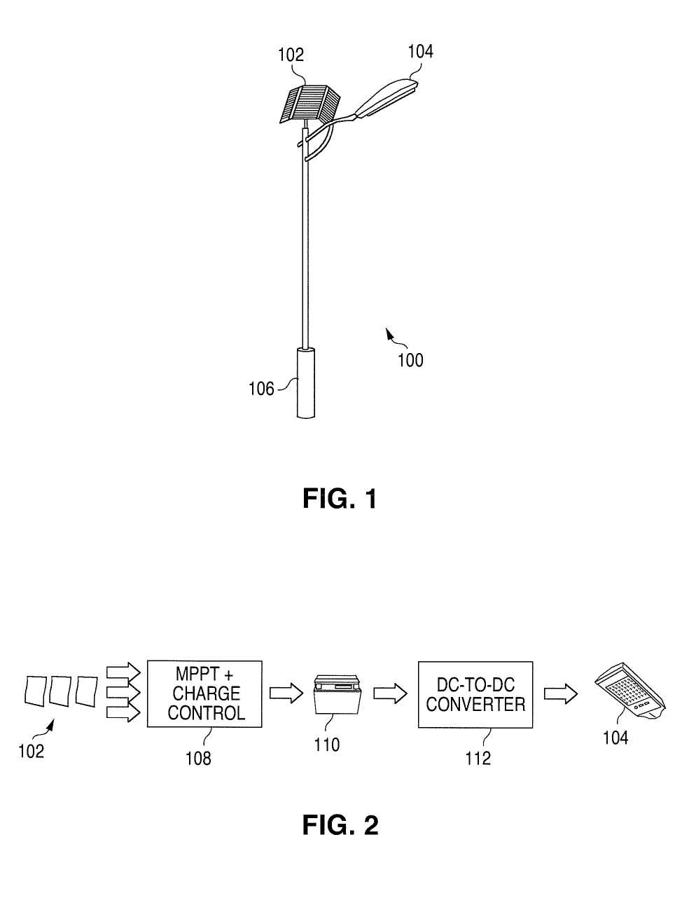

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example off-grid street lighting system 100 in accordance with this disclosure. As shown in FIG. 1, the street lighting system 100 includes multiple photovoltaic panels 102 (such as three panels), where the panels 102 are angled and facing different directions. This would allow, for example, different panels 102 to generate different amounts of energy during the day as the sun moves across the sky. As a result, each panel 102 could generate a peak amount of energy at different times. Each photovoltaic panel 102 generally represents any suitable structure for converting solar energy into electrical energy.

The street lighting system 100 also includes light emitting diodes (LEDs) 104, which produce light using power generated by the photovoltaic panels 102. The LEDs 104 include any suitable semiconductor light-emitting structure or structures. Any suitable number of LEDs 104 could be used, and the LEDs 104 could be arranged in any suitable configuration (such as in series, in parallel, or in series and in parallel).

Additional components of the street lighting system 100 could reside within a cavity 106 at a base of the street lighting system 100. Examples of the additional components are shown in FIG. 2, which is described below. The cavity 106 could represent any suitable structure in which other components of the street lighting system 100 could reside.

FIG. 2 illustrates example components in the street lighting system 100 of FIG. 1 in accordance with this disclosure. As shown in FIG. 2, the street lighting system 100 includes three photovoltaic panels 102. Note that the individual panels 102 here could be smaller than photovoltaic panels used in conventional street lighting systems. This is because conventional street lighting systems are often designed to use photovoltaic panels pointing in the same direction, so the panels obtain a single-peak power-to-voltage characteristic. In that case, larger panels may be needed to obtain the right amount of power throughout the day. As noted above and described in more detail below, the street lighting system 100 can use multiple photovoltaic panels 102 that obtain peak power-to-voltage characteristics at different times. This means that smaller photovoltaic panels 102 could be used in the street lighting system 100, which can reduce the size and cost of the system 100.

A multiple-panel MPPT unit and charge controller 108 support maximum collection of energy from the multiple photovoltaic panels 102. Various MPPT structures are disclosed in the related patent applications incorporated by reference above, although any other suitable structure for performing maximum power point tracking for multiple photovoltaic panels could be used here. The MPPT unit could include independent MPPT controllers for different photovoltaic panels 102 or an integrated single MPPT controller capable of achieving MPPT control of multiple photovoltaic panels 102. The charge controller includes any suitable structure for controlling the charging of one or more batteries or other energy storage devices.

A battery bank 110 includes one or more batteries that store energy received from the MPPT unit and charge controller 108. Each battery includes any suitable energy storage mechanism. While the use of batteries is shown here, other energy storage devices like super-capacitors could also be used.

A DC-to-DC converter 112 converts an input DC voltage from the battery bank 110 into an output DC voltage for one or more LEDs 104. The DC-to-DC converter 112 includes any suitable structure for converting a DC signal to another DC signal.

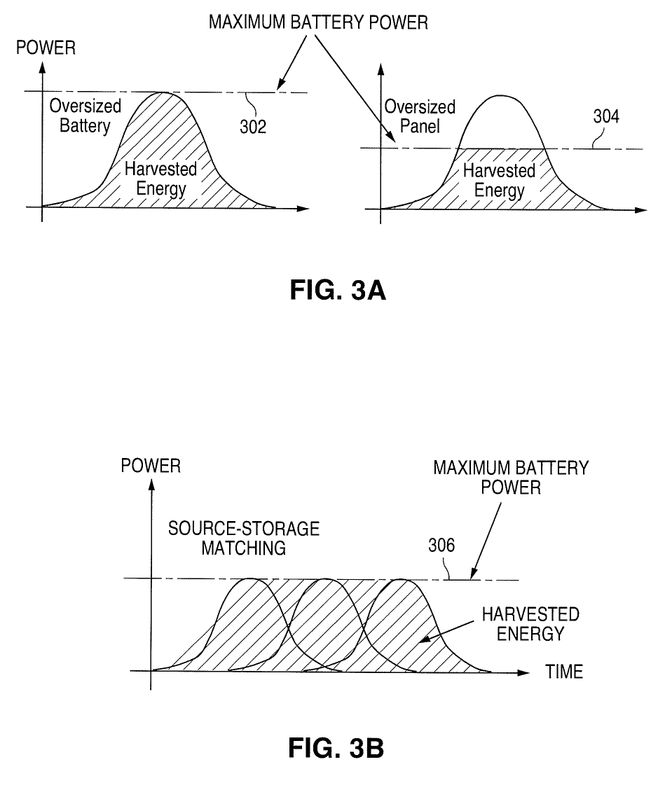

FIGS. 3A and 3B illustrate example details of matching an energy storage device's charging profile and multiple photovoltaic panels' energy output profile in accordance with this disclosure. In particular, FIG. 3A illustrates problems with matching in conventional street lighting systems, while FIG. 3B illustrates an example matching of a battery bank 110 and multiple photovoltaic panels 102 in the street lighting system 100 of FIG. 1 in accordance with this disclosure.

As shown in FIG. 3A, the output power profile of one or more photovoltaic panels in a conventional street lighting system is plotted over time. In conventional street lighting systems, a battery may be required to have enough current sinking capability to handle the large peak output power of the photovoltaic panel(s) as shown by line 302. However, this means that larger and more expensive batteries may be needed in the conventional street lighting systems. Alternatively, a battery may have a lower current rating than that required to handle the large peak output power of the photovoltaic panel(s) as shown by line 304. Unfortunately, this means that some of the output power from the photovoltaic panel(s) is not captured and stored, resulting in lost energy.

As shown in FIG. 3B, the output power profile of the photovoltaic panels 102 can be matched to the charging profile of the battery bank 110 to maximize the energy harvested in a given period of time. In particular, as shown by line 306, the battery bank 110 could have a lower current sinking capability, but ideally little to no output power from the photovoltaic panels 102 is being lost. Because of this, smaller and less expensive energy storage devices could be used without losing much if any power from the photovoltaic panels 102.

This matching can be achieved by using photovoltaic panels 102 with different orientations, so individual photovoltaic panels 102 present different output power profiles throughout the day. Collectively, however, the output power profiles of the photovoltaic panels 102 when combined could be at or near the current sinking capability of the battery bank 110. The optimal photovoltaic output power profile for a given battery type and period of time can be determined and then achieved by setting the angle(s) at which the photovoltaic panels 102 are installed. This matching can help to provide improved or maximized energy harvesting.

In some embodiments, the angle(s) between the photovoltaic panels 102 can be determined based on the location of the street lighting system 100. In these embodiments, a web-based or other application executed remotely (such as on a remote server or other device) or a stand-alone application executed locally (such as on a local computer or other device) can be used to determine the optimal angle(s) between the photovoltaic panels 102. For example, the location of the street lighting system 100 could be provided by a user, or the location could be obtained using other mechanisms (such as GPS location sensing). However the location is determined, the application could use the location of the street lighting system 100 to determine the optimal angle(s) between the photovoltaic panels 102. In particular embodiments, the optimal output power profile of a set of photovoltaic panels 102 for a given battery type and period of time could be determined based on statistical meteorological data using one or more optimization algorithms. The optimal output power profile of the photovoltaic panels 102 can then be achieved by setting the angle(s) at which the photovoltaic panels 102 are installed.

In some embodiments, personnel could install the photovoltaic panels 102 and manually adjust the angle(s) to the desired optimal angle(s). In other embodiments, personnel could install the photovoltaic panels 102, and an electronic mechanism (such as one or more small motors) could be used to adjust the angle(s) of the photovoltaic panels 102. The electronic mechanism could be controlled locally or remotely, such as via a wireless interface. Note that once the desired angle(s) of the photovoltaic panels 102 is/are determined, any suitable technique could be used to set the angle(s) of the photovoltaic panels 102 or to alter the existing angle(s) of the photovoltaic panels 102.

The street lighting system 100 in FIG. 1 may or may not include one or more backup power sources to be used if the photovoltaic system is unable to produce adequate energy for the street lighting system 100 (assuming that possibility exists). These backup power sources could include wiring to an electrical grid, a fuel cell, or any other suitable source(s) of power.

Among other things, the matching between the photovoltaic panels' output energy profile and the battery's charging profile allows a maximum amount of power generated by the photovoltaic panels 102 to be extracted and harvested. Also, smaller batteries can be used in the battery bank 110. Batteries are often the least reliable component of this type of LED street lighting system 100, so the batteries are often the component that has to be replaced most frequently. Smaller batteries may enable easier and cheaper maintenance of the LED street lighting system 100.

Although FIGS. 1-3B illustrate an example off-grid street lighting system 100 and related details, various changes may be made to FIGS. 1-3B. For example, any number of photovoltaic panels 102 can be used, each photovoltaic panel 102 can have any suitable size (and different sizes could be used), and any suitable configuration of those photovoltaic panels 102 can be used. Also, any suitable energy storage mechanism and power converter could be used in the street lighting system 100. In addition, while FIG. 3B shows that the harvested energy is generally constant between the first and last peaks, there could be some variation in the harvested energy during this time.

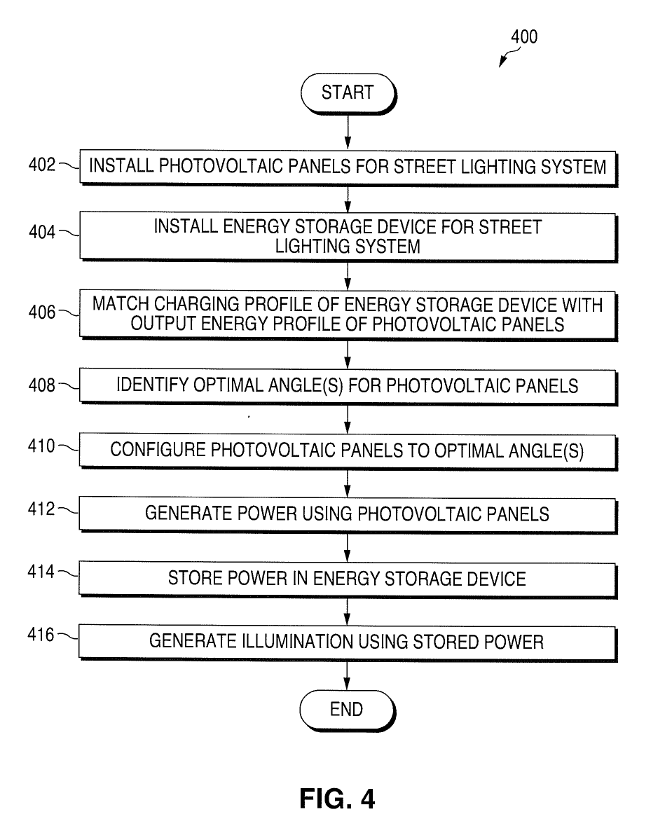

FIG. 4 illustrates an example method 400 for powering an off-grid street lighting system using multiple panel-storage matching according to this disclosure. As shown in FIG. 4, multiple photovoltaic panels are installed for a street lighting system at step 402, an energy storage device is installed for the street lighting system at step 404, and a charging profile of the energy storage device is matched with the output energy profile of the photovoltaic panels at step 406. This could include, for example, installing three photovoltaic panels 102 and a battery bank 110 for the street lighting system 100. This could also include selecting the batteries in the battery bank 110 based on the expected output energy profile of the photovoltaic panels 102. The batteries could be selected to have a maximum power level approximately equal to the expected maximum power output of the photovoltaic panels 102.

One or more optimal angles for the photovoltaic panels are identified at step 408, and the photovoltaic panels are configured to the optimal angle(s) at step 410. This could include, for example, identifying the optimal angle(s) of the photovoltaic panels 102 using the location of the street lighting system 100 and statistical meteorological data for that location. The angle(s) could be selected so that the photovoltaic panels 102 achieve the maximum output power identified when matching the photovoltaic panels output energy profile with the battery bank's charging profile. The photovoltaic panels 102 could be set to have the optimal angle(s) manually or electronically.

Once installation of the components is complete, the street lighting system can generate power using the photovoltaic panels at step 412, store the power in the energy generating device(s) at step 414, and generate illumination using the stored power at step 416. This could include, for example, the photovoltaic panels 102 generating power during the day, where each photovoltaic panel 102 has a different peak power-to-voltage characteristic at a different time. Collectively, the photovoltaic panels 102 could have a relatively constant output power profile between the first peak of one photovoltaic panel 102 and the last peak of another photovoltaic panel 102. Maximum power point tracking can be used to help ensure that each photovoltaic panel 102 generates a maximum amount of power at some point during the day. This could also include storing the generated power in the battery bank 110 and powering the LEDs 104 using the stored power.

Although FIG. 4 illustrates an example method 400 for powering an off-grid street lighting system using multiple panel-storage matching, various changes may be made to FIG. 4. For example, while shown as a series of steps, various steps in FIG. 4 could overlap, occur in parallel, occur in a different order, or occur multiple times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
multiple photovoltaic panels having a combined output profile that defines energy or power generated by the photovoltaic panels over time, each photovoltaic panel configured to generate a peak amount of energy or power at a different time; and
a storage device having a charging profile and configured to be charged by the photovoltaic panels, the charging profile defining a maximum amount of energy or power sinkable by the storage device at a given time;
wherein the output profile and the charging profile are substantially matched such that a maximum level of the output profile is approximately equal to the maximum amount of energy or power sinkable by the storage device.

2. The system of claim 1, wherein the maximum level of the output profile is substantially constant over time between a first peak amount of energy or power generated by one of the photovoltaic panels and a second peak amount of energy or power generated by another of the photovoltaic panels.

3. The system of claim 1, wherein the photovoltaic panels are angled with respect to one another in order to maximize a total amount of energy or power generated during a specified time period.

4. The system of claim 3, wherein one or more angles for the photovoltaic panels are based on a location of the photovoltaic panels.

5. The system of claim 1, further comprising:
a maximum power point tracking (MPPT) unit configured to perform maximum power point tracking for the multiple photovoltaic panels; and
a charge controller configured to control charging of the storage device by the photovoltaic panels.

6. The system of claim 1, further comprising:
a power converter configured to convert power received from the storage device; and
one or more light emitting diodes configured to generate light using the converted power.

7. The system of claim 1, wherein the storage device comprises a battery bank.

8. An apparatus comprising:
a maximum power point tracking (MPPT) unit configured to perform maximum power point tracking for multiple photovoltaic panels;
a storage device configured to be charged by the photovoltaic panels, the storage device having a charging profile defining a maximum amount of energy or power sinkable by the storage device at a given time; and
a charge controller configured to control charging of the storage device by the photovoltaic panels;
wherein the charging profile is substantially matched to an output profile of the photovoltaic panels that defines energy or power generated by the photovoltaic panels over time and that is based on multiple peak amounts of energy or power generated by different photovoltaic panels at different times, the charging profile substantially matched to the output profile such that a maximum level of the output profile is approximately equal to the maximum amount of energy or power sinkable by the storage device.

9. The apparatus of claim 8, wherein the maximum level of the output profile is substantially constant over time between a first peak amount of energy or power generated by one of the photovoltaic panels and a second peak amount of energy or power generated by another of the photovoltaic panels.

10. The apparatus of claim 8, further comprising:
a power converter configured to convert power received from the storage device.

11. The apparatus of claim 10, further comprising:
one or more light emitting diodes configured to generate light using the converted power.

12. The apparatus of claim 10, wherein the power converter comprises a direct current-to-direct current converter.

13. The apparatus of claim 8, wherein the charging profile is substantially matched to the output profile of the photovoltaic panels so that substantially all of the energy or power generated by the photovoltaic panels is stored in the storage device.

14. The apparatus of claim 8, wherein the storage device comprises a battery bank.

15. A method comprising:
performing maximum power point tracking for multiple photovoltaic panels, the photovoltaic panels having a combined output profile that defines energy or power generated by the photovoltaic panels over time, each photovoltaic panel generating a peak amount of energy or power at a different time; and
charging a storage device using the photovoltaic panels, the storage device having a charging profile defining a maximum amount of energy or power sinkable by the storage device at a given time;
wherein the output profile and the charging profile are substantially matched such that a maximum level of the output profile is approximately equal to the maximum amount of energy or power sinkable by the storage device.

16. The method of claim 15, further comprising:
generating light using one or more light emitting diodes that operate using power from the storage device.

17. The method of claim 15, wherein the maximum level of the output profile is substantially constant over time between a first peak amount of energy or power generated by one of the photovoltaic panels and a second peak amount of energy or power generated by another of the photovoltaic panels.

18. The method of claim 15, wherein the photovoltaic panels are angled with respect to one another in order to maximize a total amount of energy or power generated during a specified time period.

19. The method of claim 18, wherein one or more angles for the photovoltaic panels are based on a location of the photovoltaic panels.

20. The method of claim 15, further comprising:
performing maximum power point tracking for the multiple photovoltaic panels.
